(19) United States
(12) Patent Application Publication
(10) Pub. No.: US 2020/0120463 A1
(43) Pub. Date: Apr. 16, 2020

(54) METHODS AND DEVICES FOR MANAGING RETURNABLE PRODUCT CARRIERS IN A SYSTEM FOR DISTRIBUTION OF GOODS

(71) Applicant: SONY CORPORATION, Tokyo (JP)

(72) Inventors: Anders ISBERG, Akarp (SE); Henrik SUNDSTRÖM, Lund (SE); Magnus JOHANSSON, Lund (SE)

(21) Appl. No.: 16/500,941

(22) PCT Filed: Mar. 12, 2018
(86) PCT No.: PCT/EP2018/056102

§ 371 Date: Oct. 4, 2019

(30) Foreign Application Priority Data
Apr. 5, 2017 (EP) 17165069.0

(51) Int. Cl. H04W 4/70; G06Q 10/08

(52) U.S. Cl. CPC H04W 4/70; H04W 4/80; G06Q 10/0837; G06Q 10/0833

(57) ABSTRACT

A system for distribution of goods, comprising a plurality of returnable product carriers (150) and a return station (405). Each product carrier (150) comprises a carrier member (151) for holding goods, and a wireless communications device (100) connected to the carrier member. The wireless communications device comprises an M2M radio device (110) including a radio transceiver (111) configured to communicate with a network (1); a control unit (113) connected to the transceiver; a sensor (116) connected to the control unit, configured to sense a parameter; and a short range wireless transceiver (117) configured to emit a presence signal responsive to the sensor sensing a predetermined parameter characteristic. The return station includes a triggering device (502) configured to subject the product carriers to said predetermined parameter characteristic; and a detector device (503) configured to detect a presence signal emitted from a proximate product carrier.

### TECHNICAL FIELD

This disclosure relates to management of returnable product carriers in a system for distribution of goods, by incorporating a low complexity wireless radio devices configured for machine-to-machine communication in the product carriers. In particular, solutions are provided for improved management of product carriers to determine proper operation, and for handling malfunctioning radio devices.

### BACKGROUND

Transportation of goods has traditionally involved stacking products on wooden pallets or in containers, which are designed to be carried on different types of vehicles. An example of a modern logistics system is Svenska Retursystem, which operates in Sweden. This system develops and operates a return system with the purpose to simplify and improve its customers' logistics and distribution of goods. The return system makes use of returnable product carriers in the form of returnable pallets and returnable crates of different size, and has become a standard in the national grocery industry. Crates and pallets can be used hundreds of times, and once they are worn they may be ground down and recycled.

A problem related to such type of sustainable system, where returnable product carriers are used, is to ensure that such product carriers are recirculated to be reused once goods are removed from them. Otherwise, an excessive number of product carriers may be required, which tends to counteract economic and environmental benefits of a return system.

### SUMMARY

Solutions are provided herein related to management of returnable carriers in a system for distribution of goods, designed to alleviate the aforementioned problems. The invention providing these solution is defined by the claims.

According to an aspect, a returnable carrier for transportation of goods is provided, comprising
a carrier member for holding goods, and
a wireless communications device comprising a machine-to-machine radio device, connected to the carrier member, including
a radio transceiver configured to communicate with a network;
a control unit connected to the transceiver;
a sensor connected to the control unit, configured to sense a parameter; and
a short range wireless transceiver configured to emit a presence signal responsive to the sensor sensing a predetermined parameter characteristic.

In one embodiment, the short range wireless transceiver is configured to broadcast said presence signal.

In one embodiment, said sensor is a temperature sensor and said parameter is temperature.

In one embodiment, the short range wireless transceiver is configured to emit said presence signal a predetermined time period after the sensor sensing a predetermined parameter value.

In one embodiment, the short range wireless transceiver is configured to emit said presence signal responsive to the sensor sensing a first parameter value exceeding a first threshold, followed by sensing a second parameter value not exceeding a second threshold.

In one embodiment, the short range wireless transceiver is a Bluetooth Low Energy device.

In one embodiment, the returnable carrier comprises

a boot system for the machine-to-machine radio device; and

a reset mechanism including

a reset signal transceiver, and

a reset controller connected to the reset signal transceiver and connected to the boot system to request reboot of the wireless communications device responsive to a received reset signal.

In one embodiment, the wireless communications device is encapsulated in a waterproof casing, connected to the carrier member.

In one embodiment, the wireless communications device is molded into the carrier member.

According to a second aspect, a system for distribution of goods is provided, comprising a plurality of returnable carriers comprising any of the features above; and

a return station including

a triggering device configured to subject the carriers to said predetermined parameter characteristic; and

a detector device configured to detect a presence signal emitted from a proximate carrier.

In one embodiment, the triggering device includes a carrier washing station, configured to subject carriers to a temperature exceeding a first temperature.

In one embodiment, the system comprises a control device comprising a user agent configured to communicate with a reset signal transceiver of the wireless communications device, responsive to the detector device not detecting a presence signal emitted from a proximate carrier.

In one embodiment, the system comprises a monitoring system including a network device configured to receive data from the machine-to-machine radio device through the network.

According to a third aspect, a method is provided for managing a return station for returnable carriers comprising any of the features above in a system for distribution of goods, comprising the steps of

subjecting a carrier to said predetermined parameter characteristic; and

observing detection of a presence signal emitted from the carrier upon subjecting it to the predetermined parameter characteristic.

In one embodiment, the method comprises the step of transmitting a reset signal to the carrier responsive to not detecting a presence signal.

### BRIEF DESCRIPTION OF THE DRAWINGS

Various embodiments of the invention will be described in detail below with reference made to the appended drawings, in which:

FIG. 1 schematically illustrates wireless devices in a radio communications network;

FIG. 2 schematically illustrates an embodiment of a wireless communications device according to an embodiment, suitable for operating in a system of FIG. 1;

FIG. 3 illustrates an embodiment of a flow chart of steps and operations carried out within and between entities system including a wireless communications device;

FIG. 4 illustrates an example of an embodiment of a logistics system operating with wireless communications devices;

FIG. 5 illustrates an example of a return station for product carriers in a system for distribution of goods; and

FIG. 6 schematically illustrates an embodiment of a returnable product carrier.

### DESCRIPTION OF EMBODIMENTS

The invention and its embodiment as described herein are related to a system for distribution of goods by means of returnable product carriers, such as pallets, crates and trays of predetermined configuration. In the described embodiments, the product carriers are provided with a wireless communications device for machine-to-machine (M2M) communication. This provides means for monitoring product carriers through a communications network, such as under the Third Generation Partnership Project (“3GPP”) networks commonly referred to as e.g. 3G (such as UMTS) or 4G (such as LTE). In addition to cellular networks, also non-cellular local area networks may be used, such as under the Wireless LAN standard IEEE 802.11 commonly referred to as wifi. A mechanism is also provided for checking proper function of the wireless communications devices of product carriers at a return station, and a mechanism for managing malfunctioning wireless communications devices.

M2M typically differs from customary use of radio communication by means of e.g. mobile phones, in that no user need to be in active control for setting up or carrying out the communication. A device strictly configured for M2M need as such not even incorporate a user interface, such as a display, keypad, microphone or speaker. M2M communication has, as such, been used extensively already since the introduction of GSM. Various players on the market have also implemented different proprietary systems with Low-Power Wide-Area Networks such as LoRa®, RPMA, and SIGFOX. Recently, however, dedicated technical standards have been developed which are suitable for the purpose of M2M communication. This includes e.g. MTC (Machine Type Communication), for which service requirements have been outlined in 3GPP technical specification 22.368, and is further described in various associated specifications. MTC provides e.g. extended Discontinuous Reception (DRX), with longer sleep cycles optimized for delay-tolerant, device-terminated applications. Another commitment within 3GPP relates to Narrow-band Internet of Things (NB-IOT). In 2016 3GPP completed the standardization of NB-IoT, the new narrowband radio technology developed for the Internet-of-Things, by accepting a wide number of specification changes implementing the feature of NB-IoT Release 13 (LTE Advanced Pro).

The types of communication systems referred to above are different examples of M2M network solutions, which may be implemented for communication with wireless radio devices that may be used in returnable product carriers. It is believed that the number of wireless devices operating various forms of IoT communication in general, and NB-IoT in particular, will increase rapidly in the near future. Each wireless M2M device may be configured to consume very little power, and may use a built-in battery that may last for months or years without having to be charged or replaced. Such devices may e.g. be used for simple monitoring of sensors and reporting of measurement data from such sensors, such as for electricity gauges, photo sensors, thermometers etc.

A potential problem with operation of low-complexity M2M devices is related to its particular character, namely that it need not have a user interface, or may be provided in a place where it cannot be readily accessed for direct physical access and interaction. The invention and the embodiments described herein are related to M2M communication and this related drawback. In the following, the detailed description outlines example embodiments of the present invention in relation to broadband wireless wide area networks, but it may be noted that the invention is not limited thereto and can be applied to other types of wireless networks where similar advantages can be obtained. Such networks specifically include wireless local area networks (WLANs), wireless personal area networks and/or wireless metropolitan area networks. Furthermore, the description will at various places make reference to IoT, and an example of a radio system for operating embodiments of the invention may be NB-IoT. However, it shall be understood that the invention is as such not limited to such a system, and may e.g. alternatively make use of MTC under LTE, but the invention is applicable also to other types of radio systems where scheduling may be required to avoid collision of co-existing radio protocols, and may also include coming systems such as discussed under the concept of NR (New Radio).

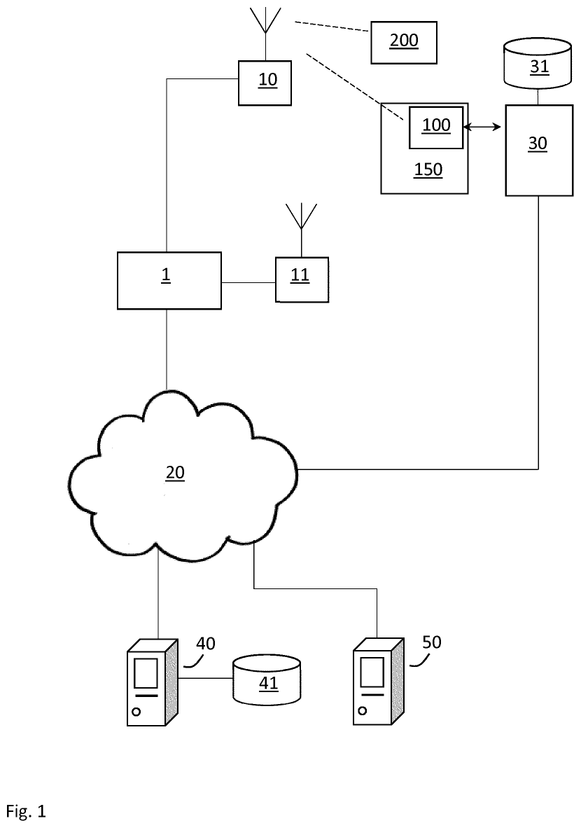

FIG. 6 illustrates an embodiment of a returnable product carrier 150, or product carrier 150 for short, in the exemplary shape of a crate with handles. Other shapes are obviously possible, and the product carrier 150 may also be provided with a closable lid or door. The product carrier 150 has carrier members 151 for holding goods, such as wall members and a floor member forming a compartment suitable. In an alternative embodiment, the carrier members may be provided in the form of a pallet, substantially only comprise a floor member, potentially having shapes or notches formed therein for securing crates thereon. The product carrier 150 further comprises a wireless communications device 100 connected to the carrier member 151, which will be further described with reference to FIGS. 1-3.

FIG. 1 illustrates, on a schematic level, a radio communications system in which an embodiment of the invention may be realized. The radio communications system may include a core network 1, which in turn may be connected to other networks 20 including the Internet. For the purpose of providing wireless radio communication, the system may include radio base stations 10, 11, which may be connected to the core network 1. In one embodiment, the base station 10 may provide radio access within a dedicated area, within which radio devices 100, 200 configured to operate in the radio communications system may be connected to the base station 10. The radio communications system may be cellular, and is mainly referred to herein in the example of LTE or New Radio, and the base station 10 may be an eNB. Alternative embodiments may be or include non-cellular, though, such as WLAN, where the radio base station 10 may be an access point.

In various embodiments, devices 100, 200 may communicate with each other or with other devices 50, through or at least under the control of the radio base station 10. In a direct communication D2D, resources may be scheduled or otherwise controlled by the base station 10, whereas communication may be carried out directly between adjacent devices 100, 200 over radio. In another embodiment, communication between devices 100, 200 will, even when they are close enough to detect each other, normally be carried out through the base station 10.

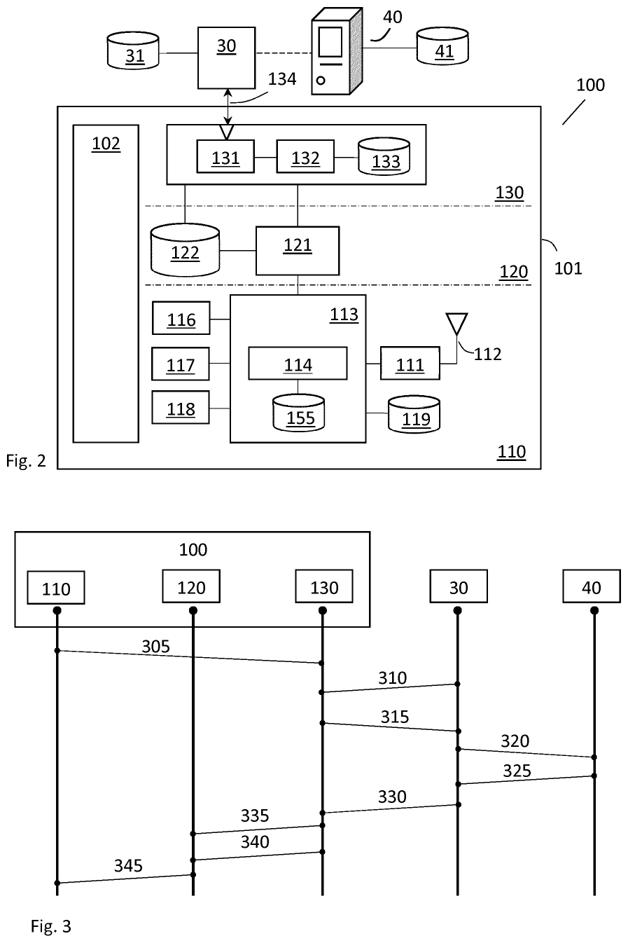

FIG. 2 discloses a block diagram of certain elements forming part of a wireless communications device 100 comprising an M2M radio device 110, also referred to as radio device herein for short, such as an IoT device for communication in a cellular network. The wireless communications device 100 may take several different forms and incorporate different functions. The radio device 110 may include a radio transceiver 111 configured to communicate with a network 1, and a control unit 113 connected to the transceiver, e.g. for managing communication according to any predetermined radio standard. In the embodiments described herein, the radio device 110 further comprises a sensor 116 connected to the control unit, configured to sense a parameter, and a short range wireless transceiver 117 configured to emit a presence signal responsive to the sensor sensing a predetermined parameter characteristic. The control unit 113 of radio device 110 may comprise one or more processors 114. A data storage device 155 including a computer readable storage medium may further be included, storing programming for execution by processors of the controller 113. Additional software programs or code may reside in other entities, accessible as cloud-based through the core network 1. The radio transceiver 111 may be connected to an antenna 112. A power supply 102 may supply power where required in the wireless communications device 100. Preferably, the power supply is provided in the shape of a non-removable battery 102.

As will be readily understood by the skilled reader, the wireless communications device 100 may comprise a number of other features and functions, such as different sensors, sensor interfaces or other components 116, 117, 118. As an example, a temperature sensor 116 may be included, as well as the short range wireless transceiver 117. Alternative or additional sensors may include an accelerometer for determining motion, a humidity sensor, an air pressure sensor etc. In addition, a GPS receiver 118 may be included, from which the control unit 113 may retrieve location data for the wireless communications device 100, and report that to the monitoring system 50 through the radio network 1. The radio device is an M2M device and may thereby be configured to communicate with a network 1 by radio, e.g. as an NB-IoT device, by means of the radio transceiver 111. The radio device 110 is preferably configured to communicate at low data rate and/or with long cycles of inactivity between transmissions. The actual characteristics of radio communication are not the within the scope of this disclosure, and are thus not discussed in any further detail. However, the character of wireless communications device 100 is preferably that of low complexity and cost, and small size, such that it may be suitably incorporated in various structures and provided in large volumes.

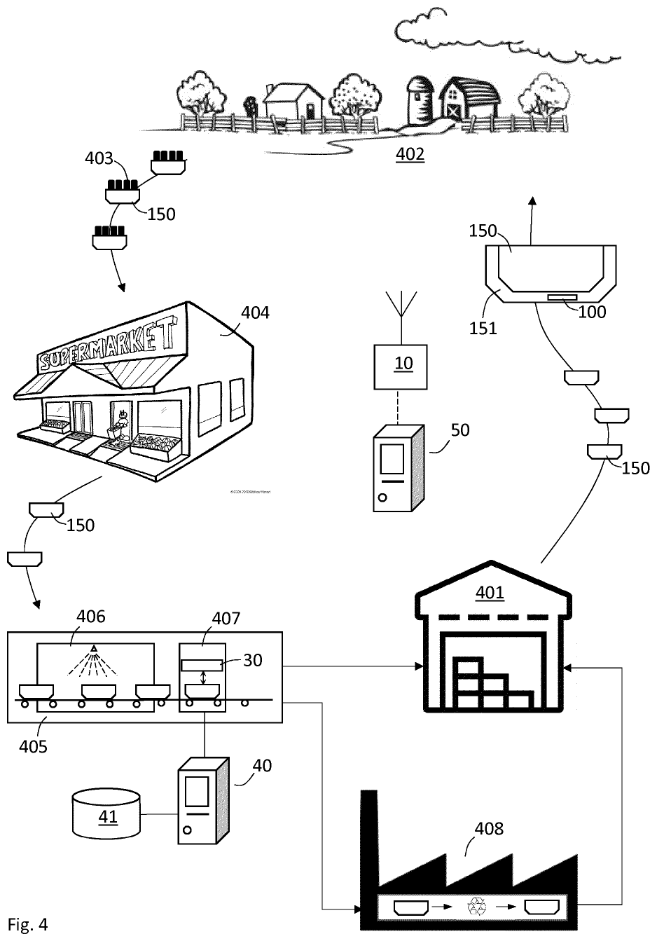

An example of a system incorporating the wireless communications device in accordance with any of the embodiments outlined herein will now be described with reference to FIG. 4. In this drawing, a system for distribution of goods is provided, which makes use of returnable product carriers 150. In this context, it is the carrier 150 as such that is returnable, and which may be used to carry or transport any type of products. An example of such a system may be Svenska Retursystem, which shall be understood as one example of the context of the system. The drawing shows a multitude of product carriers 150, or which one is enlarged to show various features of one embodiment of the product carrier 150.

Each product carrier 150 forming part of the system may include a carrier member 151, such as a support plane of a pallet, or floor and walls forming the compartment of a crate or tray, configured to support goods of either a general character or of a specific type. Furthermore, each carrier 150 includes a wireless communications device 100 as described, though it may be noted that the system may also include further product carriers which do not include a wireless communications device 100. The product carriers 150 are preferably fabricated in a plastic material, and the wireless communications device 100 is preferably provided in a casing or encapsulation 101 which is resistant to wear, water and humidity. In one embodiment, the wireless communications device 100 is attached to the carrier member 151 by screws, bolts, rivets or an adhesive. In another embodiment, the wireless communications device 100 is molded into the carrier member 151, such as in a floor part or wall part of a product carrier member, as exemplified in the enlarged product carrier 150 in FIG. 4.

In the embodiments described herein, the system may operate a monitoring system 50 including a network device 10 configured to receive and possible transmit data from a machine-to-machine radio device 101 of the wireless communications devices 100 through the network 1 (see FIG. 1). As mentioned, the network 1 may e.g. include a cellular radio network such as LTE, and the wireless communications devices 100 may be IoT devices configured for M2M communication. The operation of this monitoring system 50 makes it possible to control e.g. the balance of product carriers 150 at various locations of the system.

On a general level, the system may comprise a multitude of product carriers 150, some of which may be in storage 401. A product supplier 402, such as a factory, a packing company or a farm, may receive or retrieve a plurality of product carriers 150, and fill them with products 403 for distribution. By means of any suitable means for transportation, the filled product carriers 150 are provided to other entities, such as retailers 404, storage or restaurants, where the products are taken out of the product carriers 150. The empty product carriers are subsequently provided to a return station 405 for cleaning, after which they may be either used again, or be scrapped or even recycled to make new product carriers 150 or other products at a recycling station 408.

In case the product carriers 150 are not reachable by radio communication from the monitoring system 50 when distributed in the system, it may e.g. be difficult maintain an overview of where all the product carriers are located in the system. Even if they are primarily intended for the distribution of goods, they may end up in storages at the place 404 where the goods are delivered, which may result in shortage of product carriers 150 for distribution to product suppliers 403. The return station 405 preferably includes a carrier washing station 406, and also a control device 407. In accordance with the system as shown and described with reference to the example of FIG. 4, the opportunity to reset the radio device 101 of the wireless communications device 100 in the product carriers 150 is provided by means of a control device 407 at the washing station 406. However, further or alternative locations for this device 407 other than at the washing station may be conceivable in various embodiments. The control device 407 may include a user agent 30 configured to communicate with a reset signal transceiver 131 of the wireless communications device 100 incorporated in the product carriers 150 present at or passing the control device 407. The reset may be configured and carried out as exemplified with reference to FIGS. 1-3 herein.

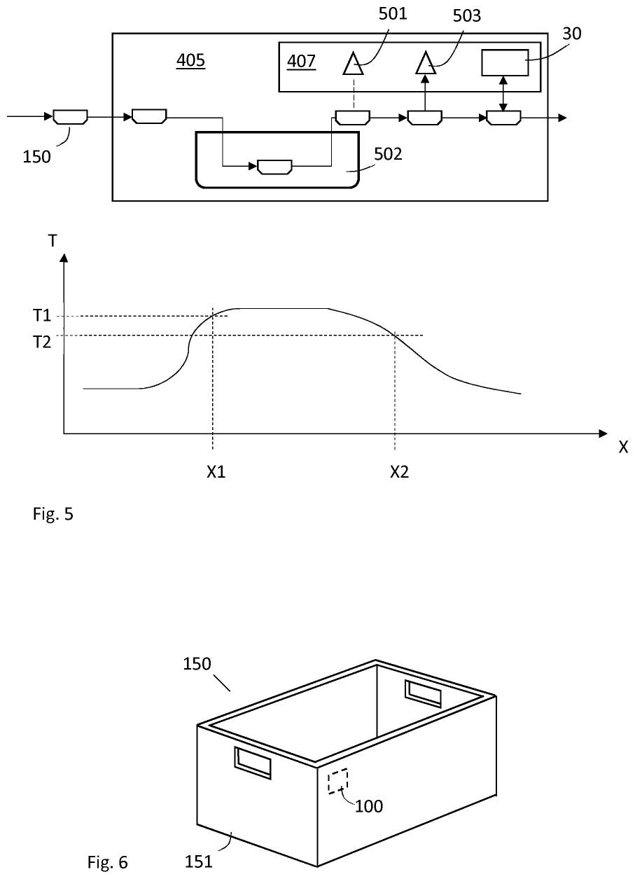

FIG. 5 illustrates an embodiment of a return station 405, which may be used in the system of FIG. 4. In a preferred embodiment, the return station 405 and the wireless communications devices 100 in the product carriers 150 are configured to include mechanisms for determining whether the wireless communications devices 100 operate properly. In this embodiment, the return station 405 is configured to receive and clean product carriers 150, such that they may again be used for transporting goods, e.g. as explained with reference to FIG. 4. As noted above, The radio device 110 in the product carriers 150 comprises a sensor 116 configured to sense a parameter, and a short range wireless transceiver 117 configured to emit a presence signal responsive to the sensor sensing a predetermined parameter characteristic. This functionality is used in the return station 405 to determine proper function of the radio device 110. First of all, a triggering device 502 is included in the return station 405, configured to subject the product carriers 150 to said predetermined parameter characteristic. Furthermore, a detector device 503 is configured to detect a presence signal emitted from a proximate product carrier 150. Hence, by subjecting the product carriers 150 to the predetermined parameter characteristic, the detector device 503 is expected to detect a presence signal. So, by observing detection of a presence signal, it may in one embodiment be determined that the radio device 110 of the product carrier 150 is operating properly if the presence signal is detected, and that the radio device 110 is not working properly if no presence signal is detected when expected. For product carriers 150 in the latter case, a reset mechanism may selectably be signaled by the user agent 30 as described herein.

In one embodiment, the presence signal may be broadcast. The presence signal is configured to constitute an “I am alive” message, to indicate to the return station 406 that “Im not bricked or in an erroneous state so you don't have to take action”. In one embodiment, the short range wireless transceiver 117 may be a Bluetooth Low Energy (BLE) transceiver.

In a preferred embodiment, the triggering device includes a carrier washing station 406, configured to subject product carriers to a temperature exceeding a first temperature T1. This may be a shower type cleaning station 406, and/or a bath 502 as shown in FIG. 5. A benefit of a solution where the parameter 116 which is sensed to trigger transmission of the presence signal is temperature, is that it can be suitably used for checking proper functioning of the radio device 110 at the cleaning station 406. For one thing, a certain raised temperature employed at cleaning will typically be used, and also maintained for a time period sufficient to securely sense it in a temperature sensor 116. Other parameters, such as humidity or pressure, could alternatively be used, though. So, by associating the triggering of the presence signal to a specific part in the cleaning process it is possible to control the window when to transmit data from the transceiver 117. It is, for obvious reasons, not desirable that the wireless communications devices 100 in the product carriers 150 broadcast presence signals for several different reasons that may be triggered by accident. It will, not only, use unnecessary power which already is a scarce resource but may will also flood the BLE radio communication spectrum. In a system such as the one illustrated in FIG. 4 there may be hundreds or thousands of product carriers 150 within the return station 405 at the same time. Using temperature as a trigger could cause false triggers, for example if the product carrier 150 is in a very warm climate directly in the sun. This may then trigger an “I'm alive” broadcast from transceiver 117, but there will in such a case typically be no detector device 503 present and no unintentional reset will be done.

In one embodiment, as illustrated in FIG. 5, a chemical bath 502 is employed in the washing station 406, in which a washing liquid is heated to T_{clean} degrees, such as 60 degrees Celsius. All product carriers 150 provided to the return station 405 are subjected to cleaning, by placing them in the bath 502 for an amount of time. The wireless communications device 100 incorporated in the product carrier 150 is equipped with a temperature sensor 116, configured to continually or intermittently measure the temperature. The product carriers 150 may be submersed in the bath 502 for e.g. 20-30 minutes. This will cause a temperature rise in the encapsulation 101 of the wireless communications device 100 containing the sensor 116, and the detected temperature change as a parameter characteristic may then be used to trigger a BLE broadcast from the transceiver 117.

In one embodiment, the parameter characteristic used to trigger the transceiver 117 may simply be that a first parameter value exceeds a first threshold, such as that the temperature exceeds T1. Typically, this threshold should be higher than what would be expected without an active trigger, such as the cleaning bath 502, and lower than the target parameter value obtained by the triggering device, e.g. T_{clean}, such that the triggering conditions will be securely obtained.

The detector device 503 configured to detect presence signal may be provided in immediate connection to the triggering device, such as over the bath 502. It may there be configured to receive presence signals from a plurality of product carriers 150 present in the bath 502. However, water may be a bad environment for radio communication. Therefore, in one embodiment, the detector device 503 may be arranged to detect a presence signal emitted from a product carrier 150 after it has left the bath 502, which is the type of embodiment shown in FIG. 5.

In one embodiment, the short range wireless transceiver 117 may be configured to emit the presence signal a predetermined time period after the sensor 116 sensing a predetermined parameter value. In a system where product carriers 150 are transported at a predetermined speed or rate through the return station 405, this predetermined time period of postponing the presence signal may be calibrated such that the transceiver is triggered to transmit the presence signal after the product carrier has exited the bath 502. This should then occur in a region where the detector device 503 may detect it.

In one embodiment, an alternative is provided to using a predetermined time period to determine delay of emission of the presence signal counter from the point of sensing the parameter characteristic of a temperature >T1. In this alternative embodiment, the short range wireless transceiver 117 may be configured to emit said presence signal responsive to the sensor 116 sensing a first parameter value exceeding a first threshold T1, followed by sensing a second parameter value not exceeding a second threshold T2. This would provide a truly temperature-related parameter characteristic. When the temperature exceeds above T1, the sensor initiates triggering, but the triggering of the presence signal is not effectuated until the temperature again falls below a temperature T2. This will indicate that the product carrier 150 is securely out of the bath 502. Also, this may correspond to a suitable distance of transportation from X1 to X2 in the return station to a region of the detector device 503. Typically, the parameter characteristic includes some hysteresis function to prevent unnecessary repeat triggers.

In one embodiment, the wireless transceiver is configured to transmit a presence signal continuously or intermittently for a time period during which it will for sure pass the detector device 503, and stop transmitting after that time period.

A general purpose is to determine if a radio device 110 in a product carrier has assumed an erroneous/bricked state in which it is malfunctioning or completely non-operative, and thus needs to be reset. In such a state, the wireless transceiver 117 will not transmit any presence signal, even if the proper conditions fulfilling the predetermined parameter conditions for the sensor 116 are met. Since the function of using a presence signal is to indicate that the radio device 110 is functioning properly, a function may also be included to determine when no such presence signal is detected, i.e. when the radio device is not working properly. In FIG. 5 this is exemplified by means of presence detector 501, such as a photodetector, a scale, vibration sensor or similar, that detects the presence of a product carrier 150. This may be provided before or at the triggering device 502 and connected to the detector device 503 such that the latter may determine when the product carrier 150 will be received in the area where its presence signal should be expected. Alternatively, the presence detector 503 may be provided at or near the detector device 503, after the triggering device 502, as in the drawing.

In one embodiment, a user agent 30 is configured to communicate with a reset signal transceiver 131 of the wireless communications device, responsive to the detector device 503 not detecting a presence signal emitted from a proximate product carrier. Various ways of realizing this feature will now be discussed, by referring to FIGS. 2 and 3. In accordance with various embodiments presented herein, the wireless communications terminal may comprise, in addition to the radio device 110, a boot system 120 for the radio device, and a reset mechanism 130 connected to the boot system for requesting reboot of the radio device, as will be described. It will be clear to the skilled reader that different functional elements described as related to the radio device 110, the boot system 120 and the reset mechanism 130 may share physical features, such as processor power, memory storage and power supply, unless otherwise specified. The elements of FIG. 2 shall therefore primarily be understood as functional. Both the boot system 120 and the reset mechanism 130 are preferably contained in a more reliable configuration than the radio device 110, in terms of software code protection.

The boot system 120 of the wireless communications device 110 preferably comprises a boot ROM 121, which is communicatively connected to the control unit 113 of the radio device 110. A non-volatile memory 122 is further included, and accessible to the boot ROM 121. The non-volatile memory 122 is configured to store one or more boot flags, which are usable by the boot ROM 121 for rebooting the radio device 110. The boot system may be selectably operated to reboot the radio device when required. This may e.g. be initiated by means of Firmware upgrade Over The Air (FOTA), using radio transceiver 111 to receive re-boot instructions and or boot flags.

If the radio device 110 is non-operative due to some malfunction, the option of initiating reset over radio is not open. If there are no accessible user interface, the battery is non-removable, and the radio interfaces are dead, the problem is how to make the device 110 reset. For this purpose, the reset mechanism 130 includes a reset signal transceiver 131, and a reset controller 132 connected to the reset signal transceiver 131 and connected to the boot system 120 to request reboot of the radio device 110 responsive to a received reset signal. This way a reset mechanism 130 is provided that allows resetting a radio device 110 regardless of the device software state. A benefit with such an embodiment is to include a reliable subsystem, including the reset mechanism 130 and the boot system 120, which is independent of the normal, and unreliable, device functions of the radio device 110. This subsystem can be triggered from the outside and takes care of resetting the system in the desired way.

In the reset mechanism 130, the controller 132 may include a processor and memory storage containing software code for execution by the processor. In operation, this may realize logic to accept an external signal 134 received by the reset signal transceiver 131, and to trigger a device reset procedure based on that signal 134. The external signal 134 is preferably sent over a wireless interface which preferably also is reliable, in the sense that it shall be separate and independent of the unreliable radio device 110, which is the target of the reset procedure. The reset signal transceiver 131 may thus include or be connected to a radio antenna.

In one embodiment, the wireless data link 134 may be part of a wireless charging subsystem, e.g. according to Qi or A4WP. In a variant, the reset signal transceiver may be configured to operate over a RFID interface. In one embodiment, the wireless link 134 may involve Near Field Communication (NFC) signals. In another embodiment, a Bluetooth Low Energy (BLE) interface may be employed for the wireless link 134.

In its simplest form, the reset signal transceiver 131 may be configured only as a receiver. In another embodiment, it may also operate as a transmitter, as will be outlined for various embodiments below. The reset signal transceiver 131 may nevertheless be configured to communicate with a user agent 30, comprising a signal transceiver and a control member for controlling communication with the reset signal transceiver 131 over the de wireless link 134 in question. The user agent is thereby configured to transfer a reset signal to the reset mechanism 130 of the wireless communications device 100.

The reset controller 132 is preferably configured to write one or more boot flags in the non-volatile memory 122 of the boot system 120 dependent on a received reset signal 134. Reset signals may be received with control data that may be written directly to the non-volatile memory 122. In one embodiment, the reset mechanism is configured to receive reset signals 134 that include control data that need to be decoded or even decrypted before being able to write boot flags to the non-volatile memory 122. In one such embodiment, the reset mechanism 130 may include a storage device 133 storing instructions that are executable by the reset controller to 132 retrieve control data from a received reset signal 134, and to write one or more boot flags in the non-volatile memory 122 dependent on the retrieved control data. This increases the protection against tampering.

The non-volatile memory 122 may be configured to store one or more boot flags, which are usable by the boot ROM 121. This represents memory whose state survives power loss, e.g. at reboot.

The boot ROM 121 may contain logic to shut down and restart the system of the radio device 110. The boot ROM may be controlled by the state of the boot flags. Depending on the state of the boot flags, the boot ROM will reset various parts of the system state. Some different examples of reset state for the radio device 110 include:
Restart—erase a system volatile memory (RAM);
Hardware Reset—reset non-volatile hardware driver state;
Factory Reset—reset all non-volatile memory to factory defaults;
FOTA roll-back—reset all non-volatile memory to a state saved before the latest FOTA upgrade.

Components of the reset mechanism 130 and the boot system 120 may be configured by means of discrete electrical components, or as functions implemented on the same silicon die as the radio device 110.

FIG. 3 schematically illustrates various steps carried out in different embodiments, within or between the various elements as exemplified in FIGS. 1 and 2. The wireless communications device 100 is illustrated to the left, with its included main portions; the radio device 110, the boot system 120 and the reset mechanism 130. The drawing further implements the user agent 30, and an authentication server 40, involved in various embodiments as described below. In normal operation, the radio device 110 is operated to communicate with a remote control or monitoring device 50 (not shown in this drawing) by means of radio communication, preferably over a cellular system 1. As such, the radio device 110 may be an IoT device. Such communication is not the focus of this disclosure, though.

With reference to FIG. 3, a method is in one embodiment provided for resetting a wireless communications device 100, comprising a machine-to-machine radio device 110 configured for communicating with a remote network 1. The wireless communications device 100 further comprises a boot system 120 connected to the radio device 110. The method may be implemented by means of a reset mechanism operating by receiving a reset signal 310 from a user agent in a reset signal transceiver; and executing reboot 335, 340, 345 of the radio device by means of a reset controller, responsive to the received reset signal. The reset signal may be received over a dedicated wireless interface 134 to the reset mechanism 130, and several types of reset are available as outlined. The signal 134 indicates which type is requested, directly or indirectly.

In a preferred embodiment, the step of executing reboot includes

writing 335 one or more boot flags in the boot system in dependence of the reset signal by means of the reset controller;

providing 340 a reboot request to a boot ROM of the boot system by means of the reset controller; and

rebooting 345 the radio device by means of the boot ROM in accordance with the boot flags. In this process, only the controlling of the reboot from the boot ROM involves the comparatively unreliable portion provided by the radio device 110, whereas all the control steps of the reset are handled in the reliable parts of the reset mechanism 130 and the boot system 120.

The step of writing one or more boot flags in the boot system may comprise the step of retrieving control data from the received reset signal, and writing one or more boot flags dependent on the retrieved control data. As mentioned, the control data from the reset signal 134 may require decoding, decrypting or at least mapping, using data stored in a memory storage 133 of the reset mechanism, so as to determine which boot flags to write.

In a preferred embodiment, when the reset mechanism sends a reboot request to the boot ROM which starts a reboot procedure 345, a first step of that reboot may be shutting down the radio device 110. At the start of the boot procedure, the boot ROM reads the boot flags and prepares for the requested boot type. The boot ROM thereby performs device boot, and subsequently hands over to a device Secondary Boot Loader SBL (not shown).

In one embodiment, extra security enablers are added so only authorized persons or software operating as user agent 30 can trigger the reset mechanism 130. As described, the possibility to reset the wireless communications device 100 are still an important function, for example to return the device to a well-known state, remove any data from the device or if the device is malfunctioning. However, reset is a sensitive function that preferably only should be allowed by authorized persons/software. In accordance with various embodiments, such reset function can be protected using cryptographic methods by extending the reset mechanism architecture proposed above.

Returning to FIGS. 1 and 4, this embodiment outlines how cryptographic keys can be derived for the reset mechanism and how the reset request can be validated by an authentication server. In addition to parts and features described above, a reliable key storage 133 may be provided in the reset mechanism 130, where a reset key can be stored. The key storage is preferably tamper proof and it should be reliable if the radio device 110 portion of the wireless communications device 100 is malfunctioning. An authentication server 40, such as an Authorization, Authentication & Accounting Server (AAA), may be communicatively connectable to the reset mechanism 130. This authentication server 40 may be connected to the communications network 1, so as to be accessible also by means of the radio transceiver 111, but that is not required for the purpose of acting as a validation tool upon resetting the radio device 100.

In a preferred embodiment, the authentication server 40 is used for the purpose of authenticating and authorizing a user agent 30 that is invoking a reset function. Before a user agent can issue a reset request, the user agent 30 must preferably be registered and authorized to issue reset requests by an administrator of the authentication server 40. In such a circumstance, the user agent 30 is preferably in possession of an Access token that has been issued by the authentication server 40. The access token may be provided after a successful authentication and authorization procedure, for example using OAuth or other industry standard.

A device key storage 119 may be connected to the control unit 113 of the radio device, configured to hold a device key which is shared between the wireless communications device 100 and the authentication server 40. As an alternative to a shared key, an embodiment may employ a private and public key pair, wherein the device key is the public key corresponding to the authentication server's 40 private key. However, the device key may not be accessible if the radio device 110 is not operative. In order for reset to be possible if the radio device 110 is malfunctioning, there must be some cryptographic key available in some reliable component. The reset mechanism 130 thus preferably comprises a reset key storage 133, connected to the reset controller 132, configured to hold a reset key.

In a preferred embodiment, the reset key is a cryptographic key generated in dependence of the device key. The reset key should be derived in such manner that the authentication server may derive the key material. For example the reset key could be generated in the following way:

Reset Key Id=Random Number( )

Reset Key=Hash (Reset Key Id+Device Key);

This may e.g. be carried out the first time a wireless communications device 100 is started, i.e. at cold start, whereby a reset cryptographic key is generated and stored in the reliable key storage 133. In an embodiment where the Device Key is shared between the authentication server 40 and the radio device 110, the reset key can calculated by the authentication server 40 by providing the reset key Id. The shared device key may be reliably stored in a memory storage 41 connected to the authentication server 40.

Now referring to FIG. 3, various method steps related to the embodiments incorporating authentication will be outlined. When a reset signal is received 310, which signal represents a reset request from the user agent 30 to the wireless communications device 100, the reset controller 130 is preferably configured to respond by transmitting 315 a request signature to the user agent 30. This request signature may be created based on a stored reset key, e.g. retrieved from memory storage 133 by the reset controller 132. In one embodiment, the request signature may be generated by providing a Number used Once (Nonce) and potentially also a freshness timestamp, if correct time is available. This data may then be used to calculate the signature. One way of calculating signature, where HMAC is Hashed Message Authentication Code, is:

Request Signature=HMAC(Reset Key,Reset Key Id+Nonce1+Timestamp1).

The Request Signature may be sent 315 by the reset signal transceiver 131, potentially together with Reset Key Id, Nonce1, Timestamp1, to the user agent 30. The user agent 30 preferably forwards 320 all these parameters, and the Access Token stored in a memory 31 connected to the user agent 30, to the authentication server 40.

The authentication server 40 then validates the token, signature, Nonce and Timestamp. If those are valid the authentication server 40 responds 325 with an acknowledgment to the user agent 30, together with a new signature that can be cryptographic validated by the reset mechanism 130. For example:

Response Signature=HMAC(Reset Key,Request Signature+Nonce2+Timestamp2);

The user agent 30 preferably forwards the Response Signature to the reset mechanism 130, which may be thereby configured to receive 330 both an acknowledgment indicating that the request signature is validated with an access token of the user agent, and a response signature created based on the request signature. Once the reset mechanism 130 receives the response signature with the Nonce2 and Timestamp2, the reset may be started if the signature validated, as described above. Thus, the step of executing reboot 345 of the machine-to-machine radio device may be carried out responsive to successful validation of the response signature. In an alternative embodiment, corresponding mechanisms may be implemented using public cryptography. The length of cryptographic keys and hash calculations should be long enough to fulfill the security requirements.

Embodiments of the invention have been discussed in the foregoing on a general level, and with respect to certain embodiments. The skilled person will realize that where not contradictory, the disclosed embodiments above may be combined in various combinations.

1. A returnable carrier for transportation of goods, comprising
a carrier member for holding goods, and
a wireless communications device comprising a machine-to-machine radio device, connected to the carrier member, including
a radio transceiver configured to communicate with a network;
a control unit connected to the transceiver;
a boot system for the machine-to-machine radio device;
a reset mechanism including
a reset signal transceiver, and
a reset controller connected to the reset signal transceiver and connected to the boot system to request reboot of the wireless communications device responsive to a received reset signal;
a sensor connected to the control unit, configured to sense a parameter; and
a short range wireless transceiver configured to emit a presence signal responsive to the sensor sensing a predetermined parameter characteristic.

2. The returnable carrier of claim 1, wherein the short range wireless transceiver is configured to broadcast said presence signal.

3. The returnable carrier of claim 1, wherein said sensor is a temperature sensor and said parameter is temperature.

4. The returnable carrier of claim 1, wherein the short range wireless transceiver is configured to emit said presence signal a predetermined time period after the sensor sensing a predetermined parameter value.

5. The returnable carrier of claim 1, wherein the short range wireless transceiver is configured to emit said presence signal responsive to the sensor sensing a first parameter value exceeding a first threshold, followed by sensing a second parameter value not exceeding a second threshold.

6. The returnable carrier of claim 1, wherein the short range wireless transceiver is a Bluetooth Low Energy device.

7. (canceled)

8. The returnable carrier of claim 1, wherein the wireless communications device is encapsulated in a waterproof casing, connected to the carrier member.

9. The returnable carrier of claim 8, wherein the wireless communications device is molded into the carrier member.

10. A system for distribution of goods, comprising
a plurality of returnable carriers, each returnable carrier comprising
a carrier member for holding goods, and
a wireless communications device comprising a machine-to-machine radio device, connected to the carrier member, including
a radio transceiver configured to communicate with a network;
a control unit connected to the transceiver;
a sensor connected to the control unit, configured to sense a parameter; and
a short range wireless transceiver configured to emit a presence signal responsive to the sensor sensing a predetermined parameter characteristic; and
a return station including
a triggering device configured to subject the returnable carriers to said predetermined parameter characteristic; and
a detector device configured to detect a presence signal emitted from a proximate returnable carrier.

11. The system of claim 10, wherein the triggering device includes
a returnable carrier washing station, configured to subject returnable carriers to a temperature exceeding a first temperature.

12. The system of claim 16, comprising
a control device comprising a user agent configured to communicate with said reset signal transceiver of the wireless communications device, responsive to the detector device not detecting a presence signal emitted from a proximate returnable carrier.

13. The system of claim 10, comprising
a monitoring system including
a network device configured to receive data from the machine-to-machine radio device through the network.

14. A method for managing a return station for returnable carriers in a system for distribution of goods, comprising the steps of
providing a returnable carrier comprising
a carrier member for holding goods, and
a wireless communications device comprising a machine-to-machine radio device, connected to the carrier member, including
a radio transceiver configured to communicate with a network;
a control unit connected to the transceiver;
a sensor connected to the control unit, configured to sense a parameter; and
a short range wireless transceiver configured to emit a presence signal responsive to the sensor sensing a predetermined parameter characteristic;
subjecting the returnable carrier to said predetermined parameter characteristic; and
observing detection of a presence signal emitted from the returnable carrier upon subjecting it to the predetermined parameter characteristic.

15. The method of claim 14, comprising the step of
transmitting a reset signal to the returnable carrier responsive to not detecting a presence signal.

16. The system of claim 10, wherein each returnable carrier comprises
a boot system for the machine-to-machine radio device; and
a reset mechanism including
a reset signal transceiver, and
a reset controller connected to the reset signal transceiver and connected to the boot system to request reboot of the wireless communications device responsive to a received reset signal.
